(19) United States
(12) Patent Application Publication
(10) Pub. No.: US 2021/0374853 A1
(43) Pub. Date: Dec. 2, 2021

(54) ATOMICALLY SWAPPING OWNERSHIP CERTIFICATES

(71) Applicant: HQLAx, S.a.r.l., Luxembourg (LU)

(72) Inventors: Oliver Benkert, London (GB); Guido Stroemer, Zurich (CH)

(21) Appl. No.: 17/245,639

(22) Filed: Apr. 30, 2021

Related U.S. Application Data
(63) Continuation of application No. 16/213,964, filed on Dec. 7, 2018, now abandoned.
(60) Provisional application No. 62/595,922, filed on Dec. 7, 2017.

(51) Int. Cl. G06Q 40/04; H04L 9/32

(52) U.S. Cl. CPC G06Q 40/04; G06F 21/602; H04L 9/3263

(57) ABSTRACT

A computing system performed for recording in a distributed ledger as an atomic operation a swap transaction to swap ownership of assets identified by ownership certificates. The computing system generates a swap transaction that inputs a first active ownership certificate that indicates that a first party owns a first asset and a second active ownership certificate that indicates that a second party owns a second asset. The swap transaction outputs an active swap, a first encumbered ownership certificate that indicates that the second party owns the first asset, and a second encumbered ownership certificate indicating that the first party owns the second asset. The computing system also records the swap transaction in the distributed ledger.

### CROSS REFERENCE TO RELATED APPLICATIONS

This application is a continuation of U.S. patent application Ser. No. 16/213,964, filed Dec. 7, 2018, entitled “ATOMICALLY SWAPPING OWNERSHIP CERTIFICATES,” which claims the benefit of U.S. Provisional Application No. 62/595,922, filed Dec. 7, 2017, entitled “ATOMICALLY SWAPPING OWNERSHIP CERTIFICATES,” each of the above-identified applications is hereby incorporated by reference herein in its entirety.

### BACKGROUND

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner, as represented by the new owner public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions fora bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

Although the bitcoin system has been very successful, it is limited to transactions in bitcoins or other cryptocurrencies. Efforts are currently underway to use blockchains to support transactions of any type, such as those relating to the sale of vehicles, sale of financial derivatives, sale of stock, payments on contracts, and so on. Such transactions use identity tokens, which are also referred to as digital bearer bonds, to uniquely identify something that can be owned or can own other things. An identity token for a physical or digital asset is generated using a cryptographic one-way hash of information that uniquely identifies the asset. Tokens also have an owner that uses an additional public/private key pair. The owner public key is set as the token owner identity, and when performing actions against tokens, ownership proof is established by providing a signature generated by the owner private key and validated against the public key listed as the owner of the token. A person can be uniquely identified, for example, using a combination of a user name, social security number, and biometric (e.g., fingerprint). A product (e.g., refrigerator) can be uniquely identified, for example, using the name of its manufacturer and its serial number. The identity tokens for each would be a cryptographic one-way hash of such combinations. The identity token for an entity (e.g., person or company) may be the public key of a public/private key pair, where the private key is held by the entity. Identity tokens can be used to identify people, institutions, commodities, contracts, computer code, equities, derivatives, bonds, insurance, loans, documents, and so on. Identity tokens can also be used to identify collections of assets. An identity token for a collection may be a cryptographic one-way hash of the digital tokens of the assets in the collection. The creation of an identity token for an asset in a blockchain establishes provenance of the asset, and the identity token can be used in transactions (e.g., buying, selling, insuring) of the asset stored in a blockchain, creating a full audit trail of the transactions.

To record a simple transaction in a blockchain, each party and asset involved with the transaction needs an account that is identified by a digital token. For example, when one person wants to transfer a car to another person, the current owner and next owner create accounts, and the current owner also creates an account that is uniquely identified by the car's vehicle identification number. The account for the car identifies the current owner. The current owner creates a transaction against the account for the car that indicates that the transaction is a transfer of ownership, indicates the public keys (i.e., identity tokens) of the current owner and the next owner, and indicates the identity token of the car. The transaction is signed by the private key of the current owner, and the transaction is evidence that the next owner is now the current owner.

To enable more complex transactions than bitcoin can support, some systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. For example, a smart contract may support the sale of an asset. The inputs to a smart contract to sell a car may be the identity tokens of the seller, the buyer, and the car and the sale price in U.S. dollars. The computer code ensures that the seller is the current owner of the car and that the buyer has sufficient funds in their account. The computer code then records a transaction that transfers the ownership of the car to the buyer and a transaction that transfers the sale price from the buyer's account to the seller's account. If the seller's account is in U.S. dollars and the buyer's account is in Canadian dollars, the computer code may retrieve a currency exchange rate, determine how many Canadian dollars the seller's account should be debited, and record the exchange rate. If either transaction is not successful, neither transaction is recorded.

When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide which transactions to keep and which transactions to discard. Although the execution of the computer code at each node helps ensure the authenticity of the blockchain, it requires large amounts of computer resources to support such redundant execution of computer code.

Although blockchains can effectively store transactions, the large amount of computer resources, such as storage and computational power, needed to maintain all the replicas of the blockchain can be problematic. To overcome this problem, some systems for storing transactions do not use blockchains, but rather have each party to a transaction maintain its own copy of the transaction. One such system is the Corda system developed by R3, Ltd., which provides a decentralized distributed ledger platform in which each participant in the platform has a node (e.g., computer system) that maintains its portion of the distributed ledger. When parties agree on the terms of a transaction, a party submits the transaction to a notary, which is a trusted node, for notarization. The notary maintains an UTXO database of unspent transaction outputs. When a transaction is received, the notary checks the inputs to the transaction against the UTXO database to ensure that the outputs that the inputs reference have not been spent. If the inputs have not been spent, the notary updates the UTXO database to indicate that the referenced outputs have been spent, notarizes the transaction (e.g., by signing the transaction or a transaction identifier with a public key of the notary), and sends the notarization to the party that submitted the transaction for notarization. When the party receives the notarization, the party stores the notarization and provides the notarization to the counterparties.

It is common for entities to use their assets as collateral in a contractual agreement. For example, if an entity wants to increase its cash holdings and currently owns shares of stock in a company, the entity could sell the shares to increase its cash holdings. In certain situations, however, the entity might not be able to sell the shares, or even if it could, the sale might have a negative side effect that the entity wishes to avoid. For example, the entity may be prohibited from selling the shares by government regulation (e.g., within a lock-up period after an initial public offering). An example of a negative side effect may be that the profits on the sale are considered to be short-term, rather than long-term, capital gains with a high tax rate. In these situations, the entity may take a loan from a Bank And pledge its shares of the stock as collateral, rather than selling the shares.

Even if the entity is willing to pledge the shares as collateral, the bank may not be willing to accept the shares as collateral if the shares have a low liquidity. Liquidity refers to the ability of an asset to be converted to cash. For example, if the shares cannot be traded via an established exchange or are subject to a lock-up period, the shares have a low liquidity. In contrast, if the shares can be readily traded via an established exchange, the shares may be considered to have a high liquidity.

To increase the chances of obtaining a loan, the entity may identify another entity with shares of stock with a higher liquidity and may propose to the other entity to exchange low-liquidity shares for the high-liquidity shares for a fee. If the other entity agrees, the entity may be able to then pledge the high-liquidity shares as collateral for the loan.

The exchange of assets, however, can be accompanied by some risks. One such risk may be that one of the parties to an exchange updates an ownership registry of the shares that the party previously held to be owned by the counterparty, but the counterparty fails to do so. As a result, the counterparty would be on record as owning both the shares previously owned by the party and the shares still owned by the counterparty. Another risk may be that a counterparty may sell its shares to a third party after the party has transferred ownership of its shares to the counterparty. As a result, the party would be on record as not owning any of the shares. In such a case, the only recourse for the party may be to take legal action (e.g., file a lawsuit or initiate an arbitration) against the counterparty under the terms of the exchange agreement. Another risk is that circumstances may change between the time the parties agree to the exchange and the time the parties execute the exchange. For example, the values of one of the assets may have increased or decreased significantly, making the exchange no longer desirable for one of the parties.

### BRIEF DESCRIPTION OF THE DRAWINGS

FIG. 1 illustrates an example display page for Bank A showing that Bank A is not currently associated with any ownership certificates.

FIG. 2 illustrates an example display page for Bank A for creating an ownership certificate.

FIG. 3 illustrates an example display page for Bank A showing that Bank A is currently associated with an empty ownership certificate.

FIG. 4 illustrates an example display page for Custodian 1 showing that custodian 1 is currently associated with an empty ownership certificate.

FIG. 5 illustrates an example display page for Custodian 1 for filling in the asset for the ownership certificate.

FIG. 6 illustrates an example display page for Custodian 1 showing that Custodian 1 is currently associated with a filled ownership certificate.

FIG. 7 illustrates an example display page for Bank A showing that Bank A is currently associated with a filled ownership certificate.

FIG. 8 illustrates an example display page for Bank A listing assets of a filled ownership certificate.

FIG. 9 illustrates an example display page for Bank A showing that Bank A is currently associated with an active ownership certificate.

FIG. 10 illustrates an example display page for Bank B showing that Bank B has a filled ownership certificate that is ready to be activated.

FIG. 11 illustrates an example display page for Bank A to define a swap for an active ownership certificate that it owns.

FIG. 12 illustrates an example display page for Bank A to initiate a swap.

FIG. 13 illustrates an example display page for Bank B showing a proposed swap.

FIG. 14 illustrates an example display page for Bank A describing the swap.

FIG. 15 illustrates an example display page for Bank B listing the ownership certificates associated with Bank B.

FIG. 16 illustrates an example display page for Bank A providing details of an encumbered ownership certificate.

FIG. 17 illustrates an example display page for Bank A describing a swap that has reached its maturity date.

FIG. 18 illustrates an example display page for Bank B describing a proposed maturity swap transaction.

FIG. 19 illustrates an example display page for Bank A listing the ownership certificates associated with Bank A.

FIG. 20 includes diagrams that illustrate inputs and outputs of transactions to create and swap ownership certificates.

FIG. 21 is a block diagram that illustrates components of the SOC system in some embodiments.

FIG. 22 is a flow diagram that illustrates processing of the create ownership certificate component that is invoked by an initiator.

FIG. 23 is a flow diagram that illustrates processing of a create ownership certificate component for a custodian in some embodiments.

FIG. 24 is a flow diagram that illustrates processing of a create swap component of an initiator in some embodiments.

FIG. 25 is a flow diagram that illustrates processing of a propose swap component of a notary in some embodiments.

FIG. 26 is a flow diagram that illustrates processing of an accept swap component of a counterparty in some embodiments.

FIG. 27 is a flow diagram that illustrates processing of a create swap component of a notary in some embodiments.

FIG. 28 is a flow diagram that illustrates processing of a signal maturity component of a party in some embodiments.

### DETAILED DESCRIPTION

A method and a system are provided for swapping ownership certificates via a swap transaction that is recorded as an atomic operation in a distributed ledger. In some embodiments, a swap ownership certificates (“SOC”) system coordinates the creating of ownership certificates that are outputs of create ownership certificate transactions and the creating of swaps and of encumbered ownership certificates that are outputs of create swap transactions. An ownership certificate indicates the owner of a certain asset that is identified in the ownership certificate. A create swap transaction inputs ownership certificates and outputs the encumbered ownership certificates with the owners swapped. For example, if party A is listed as the owner in ownership certificate A and party B is listed as the owner in ownership certificate B, then the create swap transaction outputs an encumbered ownership certificate A with party B listed as the owner and an encumbered ownership certificate B with party A listed as the owner. The ownership certificates may remain swapped until a swap termination criterion is satisfied, such as reaching a specified maturity date. If the asset of one of the swapped ownership certificates has a higher liquidity than the asset of the other ownership certificate, then the owner of the swapped ownership certificate with the higher liquidity asset may be able to more readily use that asset as collateral for a subsequent transaction. The SOC system swaps ownership certificates by directing that a notary determine whether the ownership certificates that are input to a create swap transaction have not been consumed and satisfy terms of the swap and, if so, notarize the create swap transaction by signing it with the private key of the notary. Notarization is performed as an atomic operation. The notarized create swap transaction can then be recorded in the distributed ledger by the parties to the swap. The create swap transaction, in addition to outputting the encumbered ownership certificates, also outputs a swap that describes the terms and current state of the swap.

The SOC system also employs techniques to minimize the computational resources needed to swap ownership certificates and to minimize the chances of an illicit use of an ownership certificate. For example, the messages sent between the nodes of the distributed ledger can be transmitted in a secure manner using public key encryption techniques, the computer processing needed to validate ownership certificates and create swap transactions can be reduced, security is increased because the ownership certificates are very unlikely to be stolen or otherwise compromised, and so on. Moreover, when the distributed ledger is not a blockchain, the computational resources required to mine a block are avoided and messages need only be sent point-to-point and not to all nodes of a blockchain.

The phrase “recorded in the distributed ledger” has a different meaning depending on whether the distributed ledger is or is not implemented as a blockchain. If the distributed ledger is a blockchain, then recording a transaction means sending the transaction to the nodes of the blockchain for adding to a block that is eventually mined. If the distributed ledger is not a blockchain, then recording a transaction typically would mean having a notary notarize a transaction, but it could also mean, for example, that when the transaction does not have any inputs, the one or more parties to the transaction would all sign the transaction without having the transaction notarized. The entities associated with a transaction include the party or parties, a notary, a custodian, an oracle, and so on, all of which sign the transaction with their private key so that the other parties can validate the signature using the public key of the signing party. As described herein, the signing of transactions and the validating of the signatures are generally not explicitly described, but should be understood to occur whenever one entity needs to ensure that another entity has approved a transaction. Also, the inputs and outputs of a transaction are considered to be the input states and output states of the transaction.

An example scenario will help illustrate the operation of the SOC system in some embodiments. In this example scenario, Bank A wants to swap shares of a stock A having a low liquidity for shares of stock B having a high liquidity that are owned by Bank B. After the shares are swapped, Bank A could then pledge the shares of stock B, because of their high liquidity, as collateral for (as an example) a short-term loan. The shares of stock A may be held in custodial account A of a custodian (e.g., Euroclear), and the shares of stock B may be held in custodial account B of the same or a different custodian. To swap ownership of the shares of stock, Bank A generates and records a create ownership certificate transaction that outputs an empty ownership certificate A that identifies Bank A as owner of custodial account A. Upon being notified of the output of the empty ownership certificate A, the custodian may generate and record a fill ownership certificate transaction that inputs the empty ownership transaction A and outputs a filled ownership certificate A that further lists the shares of stock A as the asset held in custodial account A. The custodian thus confirms that Bank A is the owner of custodial account A that holds the listed shares of stock A. A filled ownership certificate B is created in a similar manner that lists Bank B as the owner and lists the shares of stock B that are held in custodial account B. In some embodiments, a filled ownership certificate cannot be swapped until it is activated by the owner. To activate a filled ownership certificate, the owner generates and records an activate ownership certificate transaction that inputs a filled ownership certificate and outputs an active ownership certificate. The process of activating a filled ownership certificate may be a requirement imposed by regulations of a jurisdiction, may be a generally accepted account practice, may be a compliance rule of a party, and so on. Although the assets of an ownership certificate are described primarily as shares of stock, the assets can be any tangible or intangible asset that can be owned. For example, the assets can be real property (buildings), personal property (e.g., fine art and vehicles), intellectual property, letters of credit, leases, currency, and so on. Each ownership certificate may list multiple assets and different types of assets. For example, the assets of an ownership certificate may include shares of stock of different companies, shares of stock and option contracts (e.g., calls and puts), shares of stock and gold, and so on.

The SOC system may employ fewer or more transactions when creating an ownership certificate. For example, the SOC system may combine a create ownership certificate transaction and a fill ownership certificate transaction into a single create/fill ownership certificate transaction. In such a case, Bank A would generate and sign a create/fill ownership transaction and send the signed transaction to the custodian. The custodian adds a list of assets to the create/fill ownership transaction, signs the transaction, and sends it to Bank A for recording in the distributed ledger. Such a create/fill ownership certificate transaction outputs an active ownership certificate. The notary may also be invoked to, for example, track that the ownership certificate has been created. In such a case, either Bank A or the custodian could have the create/fill ownership transaction notarized.

Continuing with the example scenario, after the active ownership certificates are recorded as outputs of the activate ownership certificate transactions, Bank A may propose to Bank B a create swap transaction to swap the ownership of the active ownership certificate A and the active ownership certificate B. Bank A may make the proposal to Bank B by sending to Bank B the terms of the proposed swap. For example, the terms of the proposed swap may identify the active ownership certificate A and the active ownership certificate B, a maturity at which ownership of the swapped active ownership certificates will revert to the prior owners, and so on. When Bank B receives and accepts the proposal, Bank B may generate a create swap transaction with inputs of the active ownership certificate A and the active ownership certificate B and outputs of an active swap, an encumbered ownership certificate A with Bank B as the owner, and an encumbered ownership certificate B with Bank A as the owner. Once the create swap transaction is recorded in the distributed ledger, Bank A can use the shares of stock B as collateral and use encumbered ownership certificate B as evidence that Bank A owns the shares of stock B according to the terms of the swap.

In some embodiments, the SOC system may include components to allow the parties of the SOC system to make their ownership certificates visible to other parties so that the other parties can propose swaps. The component may allow a party to specify permissions that other parties have to see one or more of its ownership certificates. The permissions may be specified using an access control list that identifies the other parties individually or as groups (e.g., central banks) that have access to individuals or groups (e.g., with a certain liquidity level) of other parties. The component of a party may provide an application programming interface (“API”) through which other parties can request access to ownership certificates. When a request is received, the permissions are checked and the identifications and descriptions of the ownership certificates that the requesting party has permission to access are provided to the requesting party.

At the maturity time listed in the swap, the owners of the encumbered ownership certificate A and the encumbered ownership certificate B are again swapped so that Bank A is again the owner of the shares of stock A listed in a new active ownership certificate A and Bank B is again the owner of the shares of stock B listed in a new active ownership certificate B. To revert to the prior ownership of the encumbered ownership certificates, when the maturity time is reached, the SOC system may automatically record a maturity transaction that inputs encumbered ownership certificate A and encumbered ownership certificate B and outputs a new active ownership certificate A with Bank A listed as the owner and a new active ownership certificate B with Bank B listed as the owner. Alternatively, either or both Bank A and Bank B may generate and attempt to record a maturity transaction that inputs encumbered ownership certificate A and encumbered ownership certificate B and outputs a new active ownership certificate A with Bank A listed as the owner and a new active ownership certificate B with Bank B listed as the owner. If Bank A is successful in recording the maturity transaction, then Bank B will not be successful, and vice versa. The new active ownership certificate A and the new active ownership certificate B are available to be inputs to other create swap transactions between Bank A and Bank B or between Bank A and another entity and between Bank B and another entity.

Prior to recording the maturity transaction, the custodian may need to confirm that the shares of stock A listed in encumbered ownership certificate A are in custodial account A and that the shares of stock B listed in encumbered ownership certificate B are in custodial account B. If the shares are in the custodial accounts, then the custodian may sign the maturity transaction so that the prior ownership can be restored. If, however, the shares are not in a custodial account, then the custodian may generate and record a default transaction that inputs the active swap, the encumbered ownership certificate A, and the encumbered ownership certificate B and outputs a default swap, a default ownership certificate A, and a default ownership certificate B. Bank A and Bank B may then need to take some off-ledger actions (e.g., file a lawsuit) to address the default. After the default has been addressed, the custodian could use the shares of stocks that are currently in the custodial accounts to fill other empty ownership certificates or could simply close a custodial account.

In some embodiments, the SOC system may support multi-party create swap transactions. For example, a three-way create swap transaction may input active ownership certificates A, B, and C with owners of Bank A, Bank B, and Bank C, respectively, and output an active swap and encumbered ownership certificates A, B, and C with owners of Bank B, Bank C, and Bank A, respectively. A three-way swap may be useful when Bank A wants to borrow the high-liquidity assets of Bank C as collateral, but Bank C does not want to be lent the very low-liquidity assets of Bank A in exchange. In such a case, the three-way swap results in Bank A owning the high-liquidity asset of Bank C, Bank B owning the very low-liquidity asset of Bank A, and Bank C owning the low (but not very low) liquidity asset of Bank B. The parties to a multi-party swap may have other reasons for not wanting to own an asset, for example, the asset may be shares of a stock of a company that a party may not want to deal with, a party may be prohibited by law from dealing with, and so on.

Although the SOC system has been described primarily in the context of swapping ownership certificates, the SOC system may be used to support pledging, rather than swapping, of ownership certificates. For example, Bank B may have a credit exposure to Bank A as a result of a price movement relating to an over-the-counter (“OTC”) derivative contract, which may be a variation margin (“VM”) requirement under an International Swaps and Derivatives Association (“ISDA”) Credit Swap Annex (“CSA”) agreement between the parties. Under a CSA agreement, Bank B may pledge collateral to cover the amount Bank B would owe to Bank A if all transactions under a ISDA Master Agreement were terminated. To support such pledging of ownership certificates, the SOC system may support a propose pledge transaction, a create pledge transaction, and a mature pledge transaction. A propose pledge transaction is recorded that inputs an active ownership certificate (e.g., of Bank B) and outputs a proposed pledged ownership certificate and a proposed pledge. After the parties agree to the pledge (e.g., Bank A agrees that the pledge covers the credit exposure), a corresponding create pledge transaction is recorded that inputs the proposed pledge ownership certificate and the proposed pledge and outputs a pledged ownership certificate and an active pledge. When the pledge matures (e.g., at a maturity time), a mature pledge transaction may be automatically recorded that inputs the pledged ownership certificate and the active pledge and outputs the corresponding active ownership certificate.

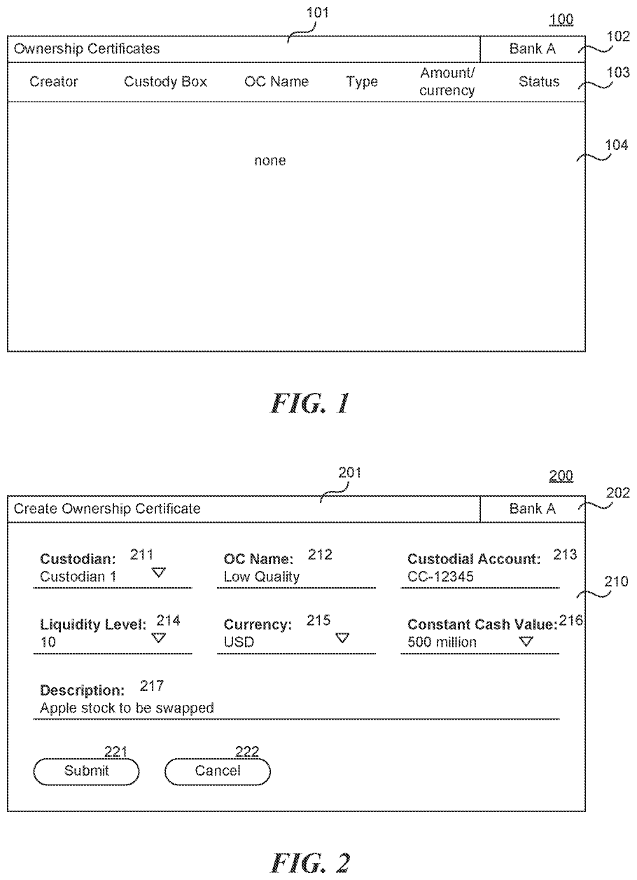

FIGS. 1-19 illustrate display pages generated by the SOC system in some embodiments. FIG. 1 illustrates an example display page for Bank A showing that Bank A is not currently associated with any ownership certificates. Display page 100 includes a title area 101, an entity identification area 102, a header area 103, and a list area 104. The title area displays the title of the display page. The entity identification area displays the identity of the entity accessing the display page. The header area displays the names of the fields of an the ownership certificate. The list area lists the ownership certificates associated with the entity. An entity may be associated with an ownership certificate if the entity is a creator or owner of the ownership certificate, the custodian of the asset of the ownership certificate, the notary who notarized the ownership certificate, and so on. In this example, the entity currently is not associated with any ownership certificates.

FIG. 2 illustrates an example display page for Bank A for creating an ownership certificate. A display page 200 includes a title area 201, an entity identification area 202, an ownership certificate area 210, a submit button 221, and a cancel button 222. The ownership certificate area includes a custodian field 211, an ownership certificate name field 212, a custodial account field 213, a liquidity level field 214, a currency field 215, a constant cash value field 216, and a description field 217. Each of fields 211 and 214-216 provide for selecting values to populate the field. The custodian field allows a user to select the custodian that holds the asset of the ownership certificate. The ownership certificate name field allows the user to enter a name for the ownership certificate for easy identification. The custodial account field allows the user to enter the identifier of the custodial account of the custodian that holds the asset. The liquidity level field allows the user to specify the liquidity of the asset. For example, the liquidity may be specified as a number from 1 to 10 with 1 being the highest liquidity. The currency field and constant cash value field allow the user to enter the cash value of the asset of the ownership certificate. The description field allows the user to enter a description of the ownership certificate. When the user has completed populating the fields, the user may select the submit button to generate and record a create ownership certificate transaction that outputs an empty ownership certificate populated with the data of the fields and indicates that Bank A is the owner of the ownership certificate. Rather than recording the create ownership transaction, Bank A may send the create ownership transaction to the custodian for filling and recording.

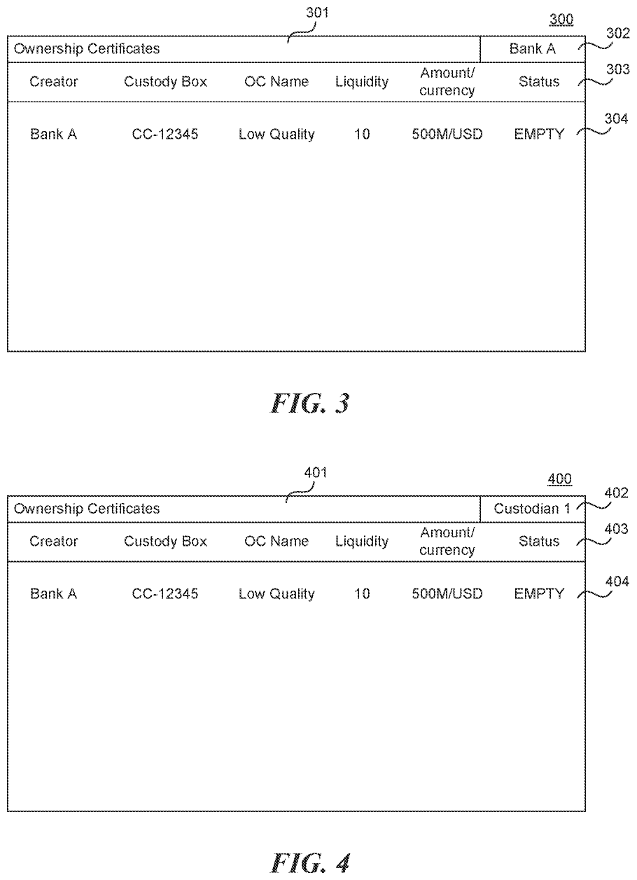

FIG. 3 illustrates an example display page for Bank A showing that Bank A is currently associated with an empty ownership certificate. A display page 300 includes a title area 301, an entity identification area 302, a header area 303, and a list area 304. The list area lists the empty ownership certificate output by the create ownership transaction of display page 200.

FIG. 4 illustrates an example display page for Custodian 1 showing that Custodian 1 is currently associated with an empty ownership certificate. A display page 400 includes a title area 401, an entity identification area 402, a header area 403, and a list area 404. The list area lists the empty ownership certificate output by the create ownership certificate transaction of display page 200.

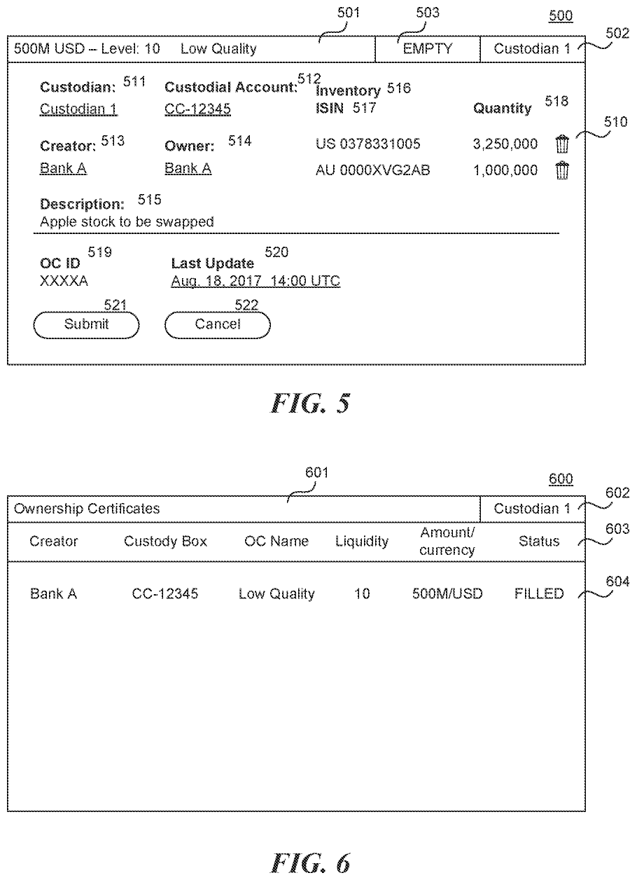

FIG. 5 illustrates an example display page for Custodian 1 for filling in the asset for the ownership certificate displayed on display page 400. A display page 500 includes an overview area 501, an entity identification area 502, a status area 503, and an ownership certificate area 510. The overview area displays the constant cash value of the ownership certificate, the liquidity level of the ownership certificate, and the name of the ownership certificate. The status area displays the current status of the ownership certificate which, in this example, is empty. The ownership certificate area includes a custodian field 511, a custodial account field 512, a creator field 513, an owner field 514, and a description field 515. The ownership certificate area also includes an inventory field 516 that includes an ISIN field 517 and a quantity field 518. The custodian field and the custodial account field identify the custodian and the custodial account that holds the asset. The creator field identifies the creator of the ownership certificate, which in this example is Bank A. The owner field lists the current owner of the ownership certificate, which in this example is Bank A. The inventory field lists the stocks that the custodian has indicated are in the custodial account. The inventory specifies the international securities identification number (“ISIN”) of the stock and a quantity. The trashcan icons are used by the custodian to remove assets that are to fill the ownership certificate. The assets may be automatically populated by a system of the custodian, manually entered by the custodian, and so on. The description field displays the description of the ownership certificate. The display page also includes an ownership certificate identification field 519 and a last update field 520 that are automatically generated by the SOC system. The SOC system may generate a unique identifier for each transaction, and the outputs are identified by a combination of the transaction identifier of a transaction that created the output and the number of the output. For example, the filled ownership certificate may be identified as XXXXA:0. The display page also includes a submit button 521 and a cancel button 522. When the custodian has completed filling in the assets held in the custodial account, the custodian selects the submit button to generate and record a fill ownership certificate transaction that inputs the empty ownership certificate and the inventory and outputs a filled ownership certificate. Bank A may have a general account with the custodian for holding all the shares of stock that Bank A owns. In such a case, Bank A may create another account to hold only the shares that are to be covered by an ownership certificate.

FIG. 6 illustrates an example display page for Custodian 1 showing that Custodian 1 is currently associated with a filled ownership certificate. A display page 600 includes a title area 601, an entity identification area 602, a header area 603, and a list area 604. The display page is similar to display page 400 except that the ownership certificate is now shown as having a status of filled.

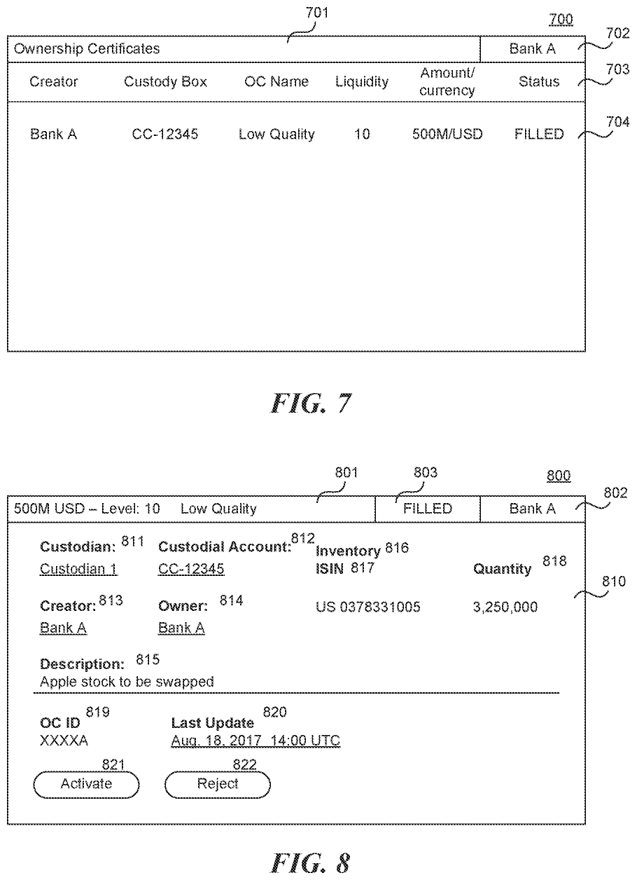

FIG. 7 illustrates an example display page for Bank A showing that Bank A is currently associated with a filled ownership certificate. A display page 700 includes a title area 701, an entity identification area 702, a header area 703, and a list area 704. The display page is similar to display page 600 except that Bank A is identified as the entity.

FIG. 8 illustrates an example display page for Bank A listing assets of a filled ownership certificate. A display page 800 includes an overview area 801, an entity identification area 802, a status area 803, and an ownership certificate area 810. The ownership certificate area includes a custodian field 811, a custodial account field 812, a creator field 813, an owner field 814, and a description field 815. The ownership certificate area also includes an inventory field 816 that includes an ISIN field 817 and a quantity field 818. The inventory field displays the stocks held in the custodial account. The display page also includes an ownership identification field 819 and a last update field 820 as well as an activate button 821 and a reject button 822. When Bank A selects the activate button, an activate ownership certificate transaction is generated and recorded that inputs the filled ownership certificate and outputs an active ownership certificate. The stocks that are listed in the display pages are merely examples, and the listed liquidity may or may not be an accurate representation of the liquidity of the shares of the stock. For example, the shares listed in the inventory field of display page 800 are for Apple Computer, which are quite likely highly liquid.

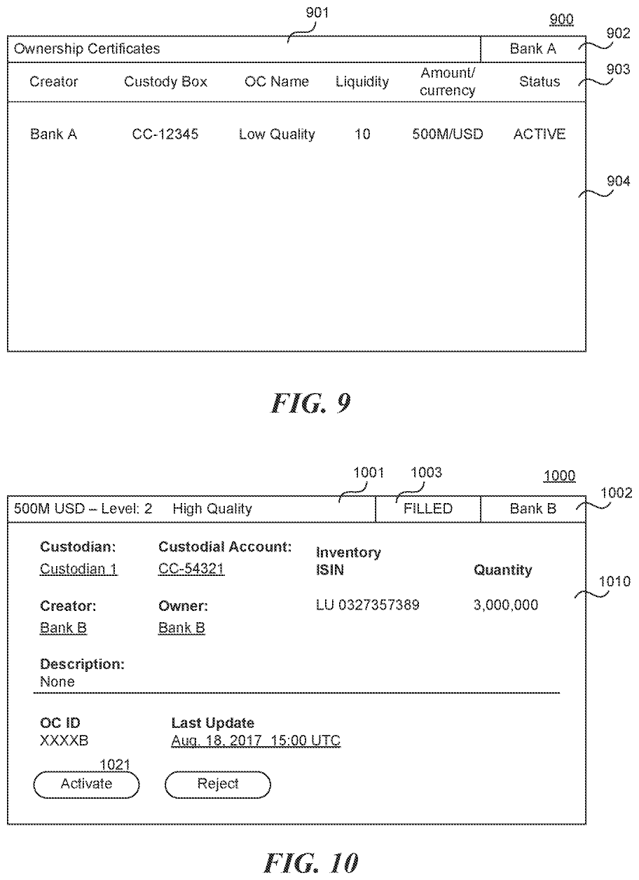

FIG. 9 illustrates an example display page for Bank A showing that Bank A is currently associated with an active ownership certificate. A display page 900 includes a title area 901, an entity identification area 902, a header area 903, and a list area 904. The display page is identical to display page 700 except that the status is active.

FIG. 10 illustrates an example display page for Bank B showing that Bank B has a filled ownership certificate that is ready to be activated. A display page 1000 includes a title area 1001, an entity identification area 1002, a status area 1003, and an ownership certificate area 1010. The title area indicates that the ownership certificate has a constant cash value of $500 million, a liquidity level of 2, and the name of “High Quality.” The entity identification area indicates that the display page is being displayed by Bank B. The ownership certificate area indicates the details of a filled ownership certificate that Bank B created and currently owns. A user selects an activate button 1021 to generate and record an activate ownership certificate transaction that inputs the filled ownership certificate and outputs an active ownership certificate.

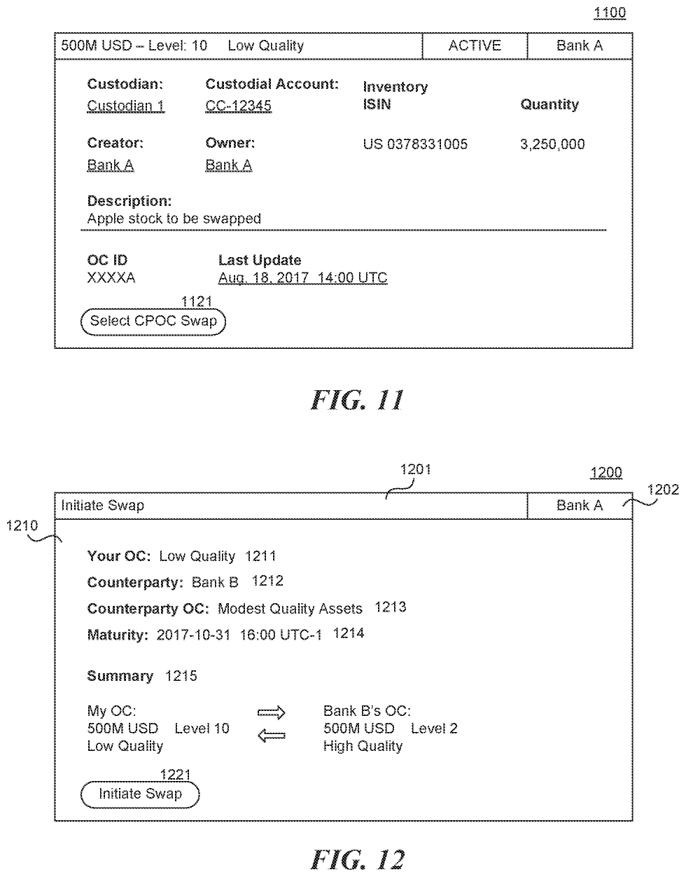

FIG. 11 illustrates an example display page for Bank A to define a swap for an active ownership certificate that it owns. Display page 1100 is similar to display page 800 except that the status is active and a select counterparty ownership certificate button 1121 is displayed. When a user selects the select counterparty ownership certificate button, a display page is displayed (not illustrated) that allows the user to select the active ownership certificate of the counterparty for the swap transaction.

FIG. 12 illustrates an example display page for Bank A to initiate a swap. Display page 1200 includes a title area 1201, an entity identification area 1202, and a swap specification area 1210. The swap specification area displays an indication 1211 of Bank A's ownership certificate and indications 1212-1213 of Bank B's ownership certificate that is to be swapped and the maturity date 1214. The swap specification area also displays a summary area 1215 that summarizes the swap. When a user selects the initiate swap button 1221, a message is sent to Bank B proposing that Bank B create a swap transaction.

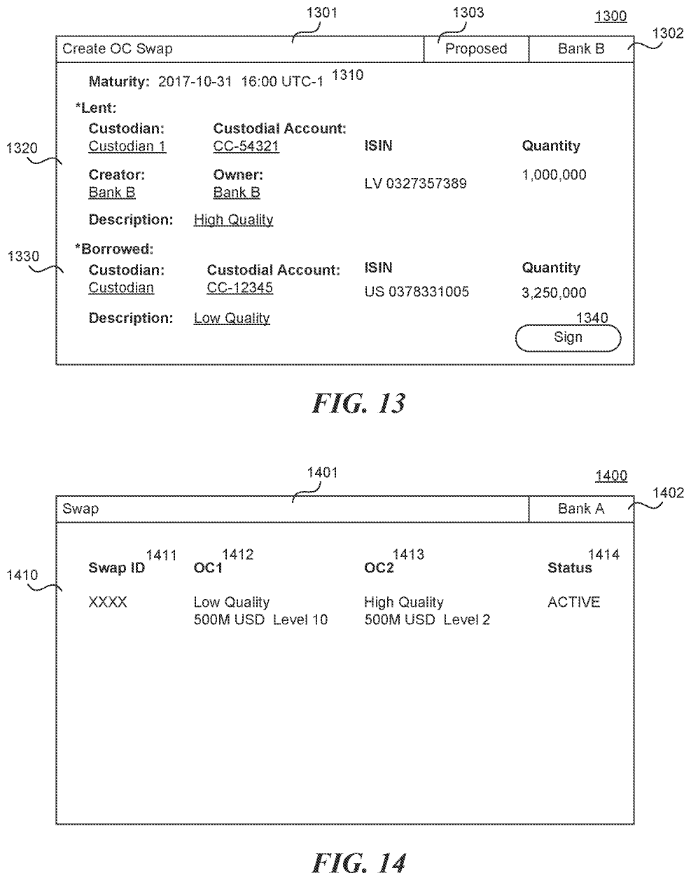

FIG. 13 illustrates an example display page for Bank B showing a proposed swap. Display page 1300 includes a title area 1301, an entity identification area 1302, a status area 1303, a maturity area 1310, a lent area 1320, and a borrowed area 1330. The status area indicates that the swap is currently in a proposed state. The maturity area indicates the maturity date of the swap. The lent area describes Bank B's ownership certificate that Bank B is to lend to Bank A. The borrowed area describes Bank A's ownership certificate that Bank B is to borrow from Bank A. When the user selects a sign button 1340, a create swap transaction is generated and recorded with inputs of the active ownership certificate of Bank A and the active ownership certificate of Bank B and with outputs of an active swap, an encumbered ownership certificate of Bank A with Bank B as the owner, and an encumbered ownership certificate of Bank B with Bank A as the owner. Bank B may send the create swap transaction to Bank A so that Bank A can sign the create swap transaction and coordinate the notarization of the create swap transaction. In some embodiments, a propose swap transaction may be recorded in the distributed ledger by Bank A as a record of the proposal. The propose swap transaction may input the encumbered ownership certificates and output proposed ownership certificates, which are then input to the create swap transaction.

FIG. 14 illustrates an example display page for Bank A describing the swap. Display page 1400 includes a title area 1401, an entity identification area 1402, and a swap area 1410. The swap area includes a swap identifier 1411, a first ownership certificate identifier 1412, a second ownership certificate identifier 1413, and a status area 1414. The display page may also indicate the maturity date of the swap.

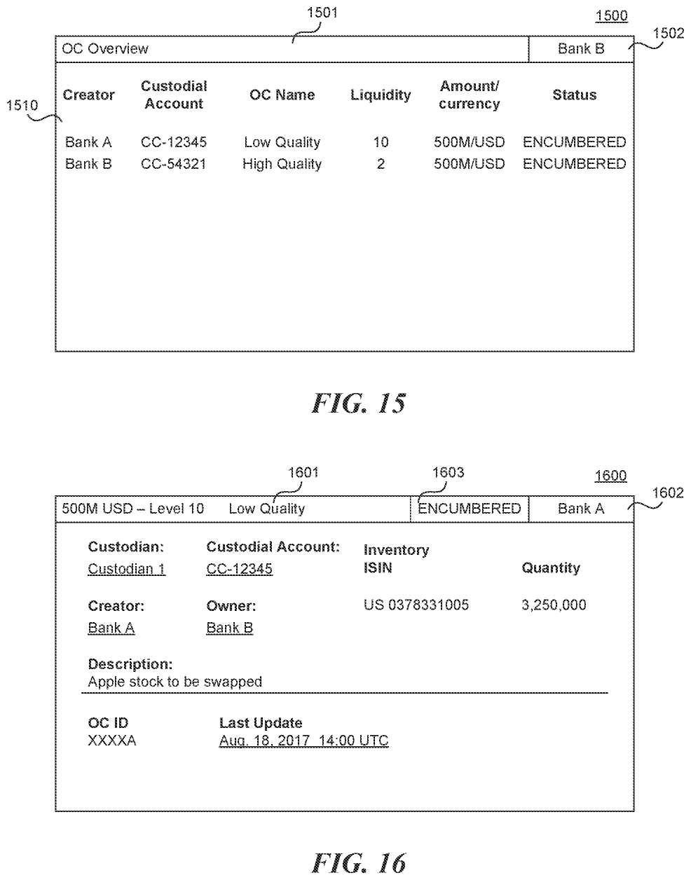

FIG. 15 illustrates an example display page for Bank B listing the ownership certificates associated with Bank B. Display page 1500 includes a title area 1501, an entity identification area 1502, and an ownership certificate area 1510. The ownership certificate area lists the ownership certificate created by Bank A and the ownership certificate created by Bank B and indicates that they are both encumbered.

FIG. 16 illustrates an example display page for Bank A providing details of an encumbered ownership certificate. Display page 1600 is similar to display page 800 except that the status is encumbered, the owner listed is Bank B, and the buttons are omitted.

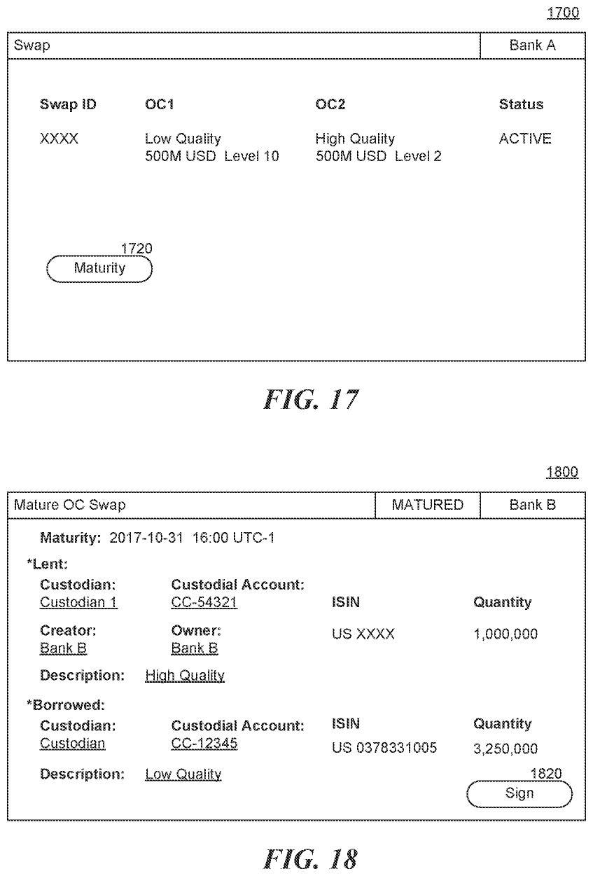

FIG. 17 illustrates an example display page for Bank A describing a swap that has reached its maturity date. Display page 1700 is similar to display page 1400 except it includes a maturity button 1720. When the maturity button is selected, a maturity swap transaction is generated with inputs of the active swap and the encumbered ownership certificates and outputs of the active ownership certificates. Bank A may have the maturity swap transaction notarized or may send the maturity swap transaction to Bank B for signing and notarizing.

FIG. 18 illustrates an example display page for Bank B describing a proposed maturity swap transaction. Display page 1800 is similar to display page 1300 except that the status is matured. When the user selects a sign button 1820, the maturity swap transaction is signed using the private key of Bank B and the signed maturity swap transaction is sent to a notary for notarization.

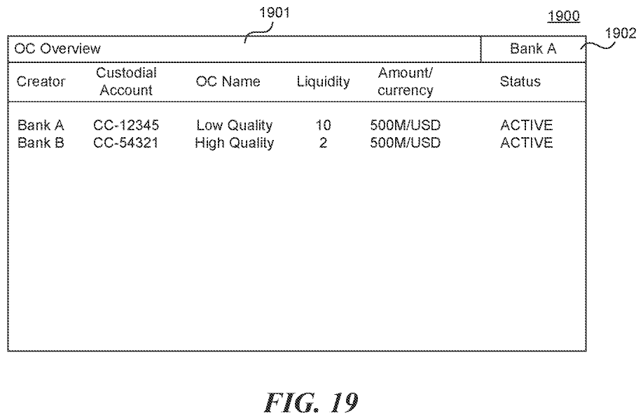

FIG. 19 illustrates an example display page for Bank A listing the ownership certificates associated with Bank A. Display page 1900 is similar to display page 1500 and illustrates that the ownership certificates are no longer encumbered because of the maturity swap transaction.

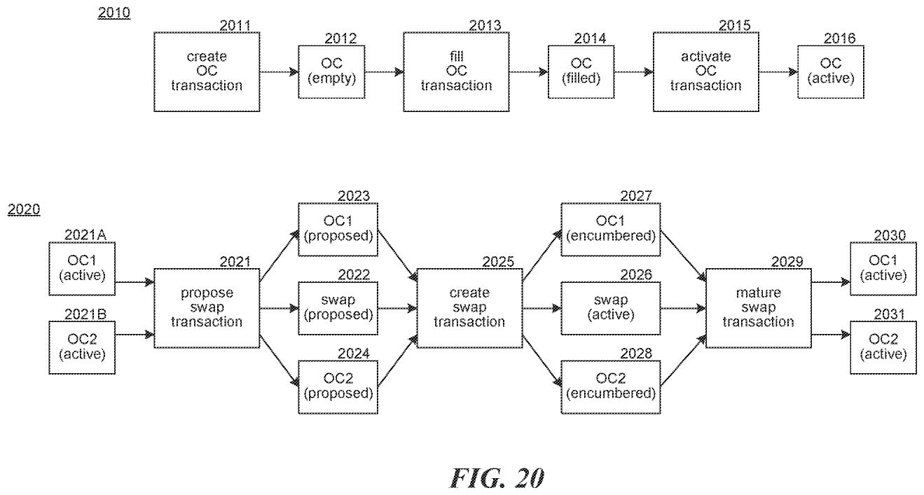

FIG. 20 includes diagrams that illustrate inputs and outputs of transactions to create and swap ownership certificates. Diagram 2010 illustrates the creating of an ownership certificate. A party generates and records a create ownership certificate transaction 2011 that outputs an empty ownership certificate 2012 as defined by the creator. After the custodian is notified, the custodian generates and records a fill ownership certificate transaction 2013 that inputs the empty ownership certificate 2012 and outputs a filled ownership certificate 2014. The party then activates the ownership certificate by generating and recording an activate ownership certificate transaction 2015 that inputs the filled ownership certificate 2014 and outputs an active ownership certificate 2016. Diagram 2020 illustrates the life cycle of a swap. A party generates and records a propose swap transaction 2021 that inputs active ownership certificates 2021A and active ownership certificate 2021B and outputs a propose swap 2022, a proposed ownership certificate 2023, and a proposed ownership certificate 2024. The party then generates and records a create swap transaction 2025 that inputs the proposed swap 2022, the proposed ownership certificate 2023, and the proposed ownership certificate 2024. The create swap transaction also outputs an active swap 2026, an encumbered ownership certificate 2027, and an encumbered ownership certificate 2028. The encumbered ownership certificates have the owners of the active ownership certificates swapped. The create swap transaction may be notarized so that the notary can designate the input proposed ownership certificates as being consumed. At the maturity time, a party generates and records a mature swap transaction 2029 that inputs the active swap 2026, the encumbered ownership certificate 2027, and the encumbered ownership certificate 2028. The mature swap transaction also outputs an active ownership certificate 2030 and an active ownership certificate 2031. The mature swap transaction may be notarized so that the notary can designate the active swap 2026, the encumbered ownership certificate 2027, and the encumbered ownership certificate 2028 as consumed.

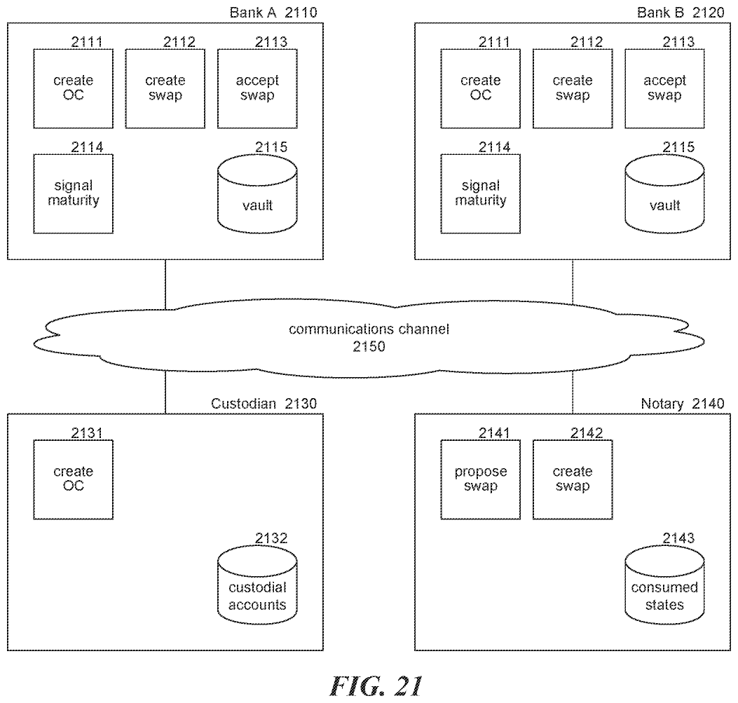

FIG. 21 is a block diagram that illustrates components of the SOC system in some embodiments. The OC system may be implemented on a Bank A system 2110, a Bank B system 2120, a custodian system 2130, and a notary system 2140. The bank systems include a create ownership certificate component 2111, a create swap component 2112, an accept swap component 2113, a signal maturity component 2114, and a vault store 2115. The create ownership swap component initiates the creation of an ownership certificate. The create swap component initiates the creating of a swap. The accept swap component coordinates the accepting of a swap that has been proposed by a counterparty. The signal maturity component coordinates the designating of the swap as having matured and the returning of the ownership certificates to an active state with their prior ownerships restored. The vault store holds a record of the transactions of Bank A. The custodian system includes a create ownership certificate component 2031 and a custodial accounts store 2132. The create ownership certificate component is invoked when a party seeks to create an ownership certificate that identifies an asset held by the custodian. The custodial accounts store contains a record of the assets in each custodial account. The notary system includes a propose swap component 2141, a create swap component 2142, and a consumed states store 2143. The propose swap component is invoked when a party proposes a swap. The create swap component is invoked when a party has created a swap transaction that needs to be notarized. The consumed states store contains information identifying the outputs of transactions that have been consumed.

The computing systems (e.g., network nodes or collections of network nodes) on which the SOC system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the SOC system. The data transmission media are used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The SOC system may be described in the general context of computer-executable instructions, such as program modules and components, executed by one or more computers, processors, or other devices. Generally, program modules or components include routines, programs, objects, data structures, and so on that perform tasks or implement data types of the SOC system. Typically, the functionality of the program modules may be combined or distributed as desired in various examples. Aspects of the SOC system may be implemented in hardware using, for example, an application-specific integrated circuit (“ASIC”) or field programmable gate array (“FPGA”).

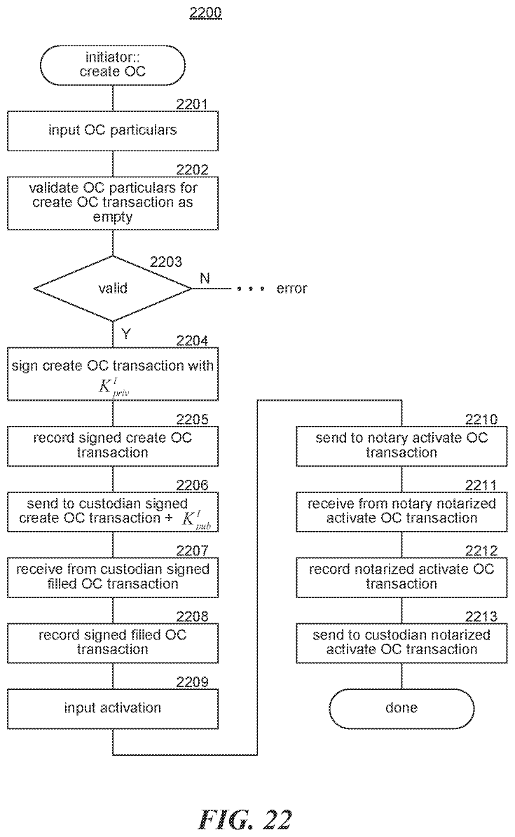

FIG. 22 is a flow diagram that illustrates processing of the create ownership certificate component that is invoked by an initiator. A create ownership certificate component 2200 is invoked so that a party can create an ownership certificate. In block 2201, the component inputs the ownership certificate particulars, such as the custodian, the custodial account, the constant cash value, the currency, and so on. In block 2202, the component validates the particulars for creating an ownership certificate transaction that is empty. The validation may include ensuring that the designated custodian is authorized to issue ownership certificates. In decision block 2203, if the ownership certificate particulars are valid, then the component continues at block 2204, else the component indicates an error. Each transaction may have a smart contract that is invoked to validate the transaction by ensuring that the particulars of a transaction, the inputs, and so on comply with the terms of the transaction that were agreed upon by the entities associated with the transaction. In block 2204, the component signs a create ownership certificate transaction with the private key of the party. In block 2205, the component records the signed create ownership certificate transaction in the vault store of the party. In block 2206, the component sends to the custodian the signed create ownership certificate transaction along with the public key (e.g., via a public key certificate) of the party. The custodian can use the public key to ensure that the transaction was signed by the party. In block 2207, the component receives from the custodian an indication of a signed filled ownership certificate transaction. In block 2208, the component records the signed filled ownership certificate transaction in the vault store. In block 2209, the component inputs a request from the party to activate the filled ownership certificate. In block 2210, the component sends to the notary an activate ownership certificate transaction so that the notary can determine whether the filled ownership certificate has been consumed and, if not, designate it as consumed, and the notary then returns the notarized activate ownership certificate transaction. In block 2211, the component receives from the notary the notarized activate ownership certificate transaction. In block 2212, the component records the notarized activate ownership certificate transaction in the vault store. In block 2213, the component sends to the custodian the notarized activate ownership transaction so that the custodian knows that an ownership certificate has been successfully created. The component then completes.

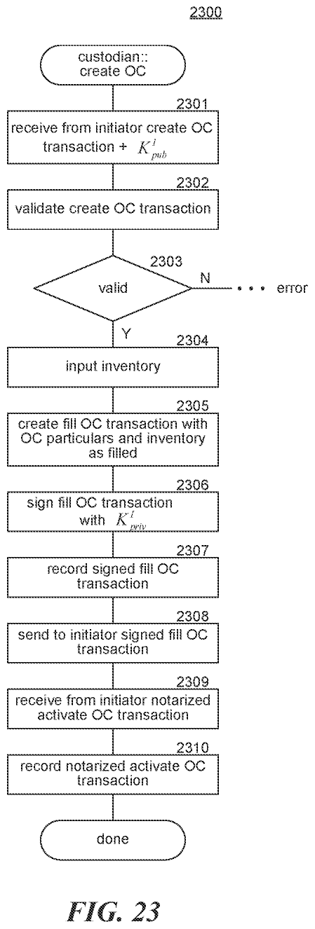

FIG. 23 is a flow diagram that illustrates processing of a create ownership certificate component for a custodian in some embodiments. A create ownership component 2300 is invoked when a custodian receives a create ownership certificate transaction. In block 2301, the component receives from the initiator the create ownership certificate transaction and the public key of the initiator. In block 2302, the component validates the create ownership certificate transaction by, for example, using the public key of the initiator to ensure that it is signed and invoking a validate method of the smart contract. In decision block 2303, if the create ownership certificate transaction is valid, then the component continues at block 2304, else the component indicates an error. In block 2304, the component inputs the inventory associated with the custodial account identified in the create ownership certificate transaction. In block 2305, the component creates a fill ownership certificate transaction with the ownership particulars of the create ownership transaction and the inventory. In block 2306, the component signs the fill ownership certificate transaction with the private key of the custodian. In block 2307, the component records the signed fill ownership transaction in a vault store of the custodian. In block 2308, the component sends to the initiator the signed fill ownership certificate transaction. In block 2309, the component receives from the initiator a notarized activate ownership certificate transaction. In block 2310, the component records the notarized activate ownership certificate transaction in the vault store of the custodian and then completes.

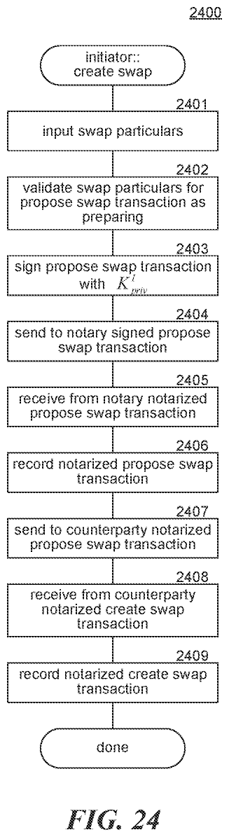

FIG. 24 is a flow diagram that illustrates processing of a create swap component of an initiator in some embodiments. A create swap component 2400 of an initiator is invoked by a party to the swap to initiate a swap. In block 2401, the component inputs the swap particulars, such as the identification of the active ownership certificates and maturity date. In block 2402, the component validates the swap particulars for the proposed swap and generates a propose swap transaction that inputs the active ownership certificates and outputs proposed ownership certificates. In block 2403, the component signs the propose swap transaction with the private key of the initiator. In block 2404, the component sends to the notary the signed propose swap transaction. In block 2405, the component receives from the notary the notarized propose swap transaction. The notary ensures that the input active ownership certificates have not been consumed. In block 2406, the component records the notarized propose swap transaction in the vault store of the initiator. In block 2407, the component sends to the counterparty the notarized proposed swap transaction. In block 2408, the component receives from the counterparty a notarized create swap transaction having the proposed ownership certificates and the proposed swap as inputs and having the encumbered ownership certificates and the active swap as outputs. In block 2409, the component records the notarized create swap transaction in the vault store of the initiator and then completes.

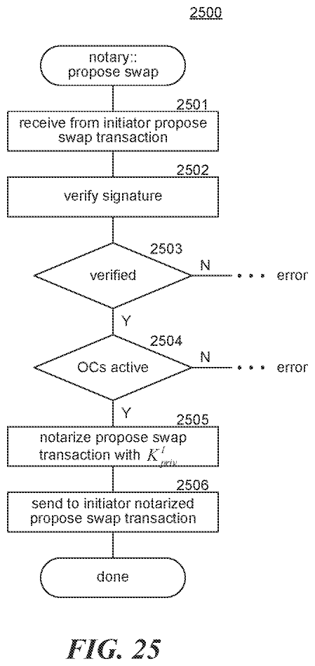

FIG. 25 is a flow diagram that illustrates processing of a propose swap component of a notary in some embodiments. A propose swap component 2500 is invoked when a notary receives a propose swap transaction that is to be notarized. In block 2501, the component receives from the initiator the propose swap transaction. In block 2502, the component verifies the signature and other particulars of the propose swap transaction. In decision block 2503, if the signatures are verified, then the component continues at block 2504, else the component indicates an error. In decision block 2504, if the input active ownership certificates of the propose swap transaction are not consumed, then the component continues at block 2505, else the component indicates an error. In block 2505, the component notarizes the propose swap transaction with the private key of the notary. In block 2506, the component sends to the initiator the notarized propose swap transaction.

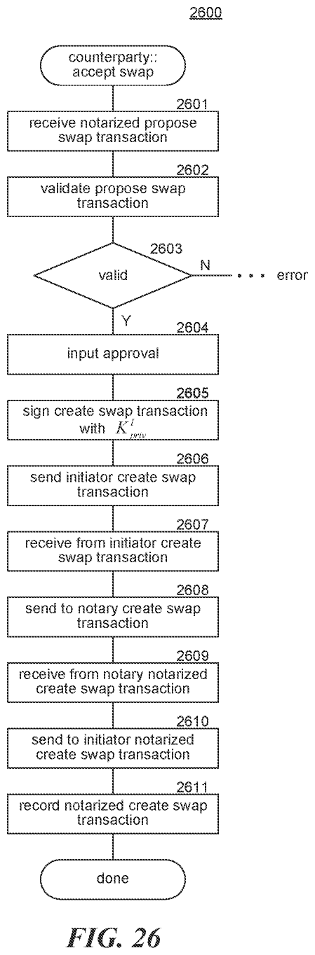

FIG. 26 is a flow diagram that illustrates processing of an accept swap component of a counterparty in some embodiments. An accept swap component 2600 of a counterparty is invoked when an initiator has proposed a swap. In block 2601, the component receives the notarized propose swap transaction. In block 2602, the component validates the propose swap transaction by, for example, checking the signature of the notary and the swap particulars. In block decision block 2603, if the propose swap transaction is valid, then the component continues at block 2604, else the component indicates an error. In block 2604, the component inputs the approval from the counterparty. In block 2605, the component creates a create swap transaction corresponding to the propose swap transaction and signs it with the private key of the counterparty. In block 2606, the component sends to the initiator the create swap transaction. In block 2607, the component receives from the initiator the create swap transaction that has been signed by the initiator. In block 2608, the component sends the create swap transaction to the notary. In block 2609, the component receives from the notary the notarized create swap transaction. In block 2610, the component sends to the initiator the notarized create swap transaction. In block 2611, the component records the create swap transaction.

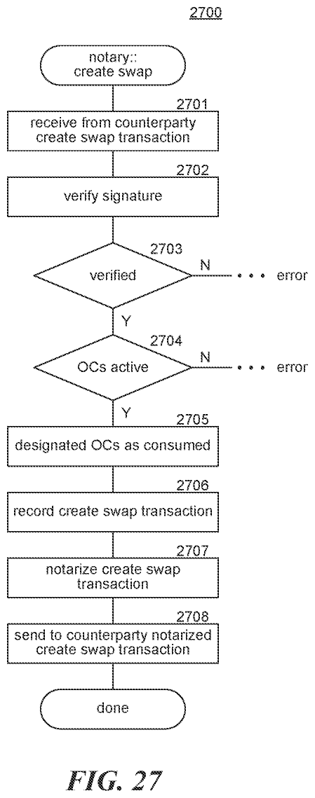

FIG. 27 is a flow diagram that illustrates processing of a create swap component of a notary in some embodiments. A create swap component 2700 of a notary is invoked when a notary receives a request to notarize a create swap transaction. In block 2701, the component receives from a counterparty a create swap transaction. In block 2702, the component verifies the signatures of the create swap transaction. In decision block 2703, if the signatures are verified, then the component continues at block 2704, else the component indicates an error. In decision block 2704, if the proposed ownership certificates have not been consumed, then the component continues at block 2705, else the component indicates an error. In block 2705, the component designates the proposed ownership certificates as being consumed. In block 2706, the component records the create swap transaction. In block 2707, the component notarizes the create swap transaction by signing with the private key of the notary. In block 2708, the component sends to the counterparty the notarized create swap transaction and completes.

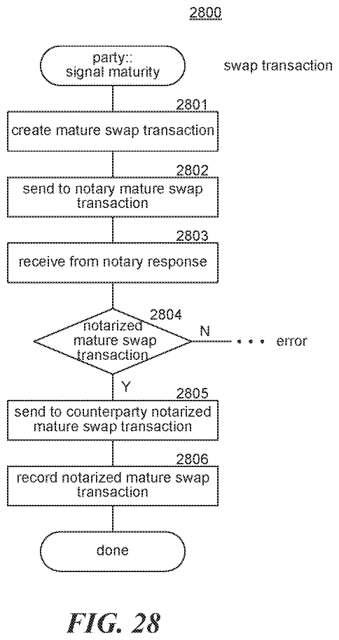

FIG. 28 is a flow diagram that illustrates processing of a signal maturity component of a party in some embodiments. A signal maturity component 2800 of a party is invoked when an active swap has matured and a party wants to revert to the prior ownership of the encumbered ownership certificates. In block 2801, the component creates a mature swap transaction that inputs the active swap and the encumbered ownership certificates. In block 2802, the component sends to the notary the mature swap transaction. The notary may ensure that the maturity date (which may include a specific time of day) has been reached and that the active swap and the encumbered ownership certificates have not been consumed (e.g., because another party has already recorded a mature swap transaction for the active swap). In block 2803, the component receives from the notary a response, which may include the notarized mature swap transaction or may indicate that it could not be notarized, for example, because the counterparty has already notarized a similar transaction. In decision block 2804, if the response includes a notarized mature swap transaction, then the component continues at block 2805, else the component indicates an error. In block 2805, the component sends to the counterparty the notarized mature swap transaction. In block 2806, the component records the notarized mature swap transaction in the vault store and then completes.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by one or more computing systems for swapping ownership certificates, the method comprising:
receiving a first identifier of a first active ownership certificate indicating that a first party owns a first asset, the first active ownership certificate being an output of a first create ownership certificate transaction that is recorded in a distributed ledger;
receiving a second identifier of a second active ownership certificate indicating that a second party owns a second asset, the second active ownership certificate being an output of a second create ownership certificate transaction that is recorded in the distributed ledger;
generating a create swap transaction that inputs the first active ownership certificate and the second active ownership certificate and that outputs an active swap, a first encumbered ownership certificate indicating that the second party owns the first asset, and a second encumbered ownership certificate indicating that the first party owns the second asset;
directing notarization of the create swap transaction; and
recording in the distributed ledger the notarized create swap transaction.

2. The method of claim 1 wherein the notarization of the create swap transaction includes designating the first active ownership certificate and the second active ownership certificate as consumed.

3. The method of claim 1 wherein the create swap transaction includes a maturity date and further comprising, upon reaching the maturity date:
generating a mature swap transaction that inputs the active swap, the first encumbered ownership certificate, and the second encumbered ownership certificate and that outputs a third active ownership certificate indicating that the first party owns the first asset and a fourth active ownership certificate indicating that the second party owns the second asset;
directing notarization of the mature swap transaction; and
recording in the distributed ledger the notarized mature swap transaction.

4. The method of claim 3 wherein the notarization of the mature swap transaction includes designating the active swap, the first encumbered ownership certificate, and the second encumbered ownership certificate as consumed.

5. The method of claim 3 wherein the notarization of the mature swap transaction includes determining whether the active swap, the first encumbered ownership certificate, and the second encumbered ownership certificate have been consumed.

6. The method of claim 1 wherein the receiving of the first identifier of the first active ownership certificate comprises:
generating a create ownership certificate transaction that outputs a first empty ownership certificate, the first empty ownership certificate identifying a custodian and a custodial account that holds the first asset;
recording in the distributed ledger the create ownership certificate transaction;
sending to the custodian the first empty ownership certificate, wherein the custodian records in the distributed ledger a fill ownership certificate transaction that inputs the first empty ownership certificate and that outputs a first filled ownership certificate that identifies the first asset in the custodial account; and
receiving from the custodian an indication of the first filled ownership certificate.

7. The method of claim 6 wherein the create swap transaction inputs the first filled ownership certificate as the first active ownership certificate.

8. The method of claim 6 wherein the receiving of the first identifier of the first active ownership certificate further comprises:
generating an activate ownership certificate transaction that inputs the first filled ownership certificate and that outputs the first active ownership certificate; and
recording in the distributed ledger the activate ownership certificate transaction.

9. The method of claim 1 wherein the first identifier identifies an activate ownership certificate transaction that outputs the first active ownership certificate.

10. The method of claim 1 wherein the first asset is held in a first custodial account of a custodian and the second asset is held in a second custodial account of the custodian.

11. The method of claim 10 wherein the first asset has a liquidity that is higher than that of the second asset.

12. The method of claim 10 wherein the create swap transaction includes a maturity date and further comprising, when the maturity date has been reached and when the first asset is no longer in the first custodial account, indicating a default by the second party.

13. One or more computing systems for swapping ownership certificates as an atomic operation, the one or more computing systems comprising:
one or more computer-readable storage mediums storing computer-executable instructions for controlling the one or more computing systems to:
generate an ownership certificate transaction that outputs a first ownership certificate, the first ownership certificate indicating that a first party owns a first asset that is held by a custodian;
direct recording of the ownership certificate transaction in a distributed ledger;
generate a swap transaction that inputs the first ownership certificate and a second ownership certificate and outputs an active swap, a first encumbered ownership certificate, and a second encumbered ownership certificate, the second ownership certificate indicating that a second party owns a second asset that is held by the custodian, the second ownership certificate being recorded in the distributed ledger, the first encumbered ownership certificate indicating that the second party owns the first asset, and the second encumbered ownership certificate indicating that the first party owns the second asset; and
direct recording of the swap transaction in the distributed ledger after the swap transaction has been signed by the first party and the second party and notarized by a notary; and
one or more processors for executing the computer-executable instructions stored in the one or more computer-readable storage mediums.

14. The one or more computing systems of claim 13 wherein the notary ensures that the first party and the second party have signed the swap transaction and that the first ownership certificate and the second ownership certificate have not been consumed.

15. The one or more computing systems of claim 13 wherein the swap transaction includes a maturity time and wherein, upon reaching the maturity time, the computer-executable instructions control the one or more computing systems to:
generate a mature swap transaction that inputs the active swap, the first encumbered ownership certificate, and the second encumbered ownership certificate and that outputs a third ownership certificate indicating that the first party owns the first asset and a fourth ownership certificate indicating that the second party owns the second asset;
direct notarization of the mature swap transaction; and
record in the distributed ledger the notarized mature swap transaction.

16. A method performed by one or more computing systems for recording in a distributed ledger a swap transaction to swap ownership of ownership certificates as an atomic operation, the method comprising:
generating a swap transaction that inputs a first ownership certificate indicating that a first party owns a first asset and a second ownership certificate indicating that a second party owns a second asset and that outputs an active swap, a third ownership certificate indicating that the second party owns the first asset, and a fourth ownership certificate indicating that the first party owns the second asset; and
recording the swap transaction in the distributed ledger.

17. The method of claim 16 further comprising directing notarization of the swap transaction, wherein the recording records the notarized swap transaction.

18. The method of claim 17 wherein the notarization of the swap transaction includes designating the first ownership certificate and the second ownership certificate as consumed.

19. The method of claim 16 wherein the recording of the swap transaction effects both the consuming of the first ownership certificate and the second ownership certificate and the outputting of the swap transaction, the third ownership certificate, and the fourth ownership certificate, wherein the third ownership certificate and the fourth ownership certificate are available to be inputs to a swap transaction.

20. The method of claim 16 wherein the swap transaction includes contract code that ensures that the first ownership certificate and the second ownership certificate comply with terms of a swap.

21. The method of claim 16 wherein the first ownership certificate identifies a first custodian that holds the first asset and the second ownership certificate identifies a second custodian that holds the second asset.

22. A method performed by one or more computing systems for creating an ownership certificate, the method comprising:
receiving an identification of a custodial account of a custodian that holds an asset of a party that owns the custodial account, an indication of a value of the asset, and an indication of a liquidity level of the asset;
recording in a distributed ledger a create ownership certificate transaction that outputs an empty ownership certificate that identifies the custodian, the custodial account, and the party and indicates the value of the asset and the liquidity level of the asset;
requesting the custodian to generate a fill ownership certificate transaction that inputs the empty ownership certificate and outputs a filled ownership certificate that identifies the asset, the custodian, the custodial account, and the party and indicates the value of the asset and the liquidity level of the asset; and
recording in the distributed ledger the fill ownership certificate transaction.

23. The method of claim 22 further comprising, prior to recording the fill ownership certificate transaction, directing a notary to notarize the fill ownership certificate transaction, and wherein the recording of the fill ownership certificate transaction records the notarized fill ownership certificate transaction.

24. The method of claim 23 wherein the notary designates the empty ownership certificate as being consumed.

25. The method of claim 22 wherein contract code of the fill ownership certificate transaction determines whether the inputs comply with terms needed to record a filled ownership certificate.
